(19) United States
(12) Patent Application Publication
(10) Pub. No.: US 2014/0297308 A1
(43) Pub. Date: Oct. 2, 2014

(54) REFERRAL AND RECORD SHARING SYSTEMS AND METHODS

(71) Applicant: MEDTEXT COMMUNICATIONS, LLC, Teaneck, NJ (US)

(72) Inventors: Howard M. BARUCH, Englewood, NJ (US); Luke Garrett ADAMS, Richmond, VA (US); Jacob David KUSTANOWITZ, Jerusalem (IL)

(21) Appl. No.: 14/303,375

(22) Filed: Jun. 12, 2014

Related U.S. Application Data
(63) Continuation-in-part of application No. 13/848,170, filed on Mar. 21, 2013.
(60) Provisional application No. 61/834,228, filed on Jun. 12, 2013.
(60) Provisional application No. 61/834,241, filed on Jun. 12, 2013.
(60) Provisional application No. 61/860,541, filed on Jul. 31, 2013.

(51) Int. Cl. G06F 19/00

(52) U.S. Cl. CPC G06F 19/327
USPC 705/2

(57) ABSTRACT

Systems and methods described herein may utilize a server comprising a processor to receive a referral request associated with a patient. The server may identify a referred health care provider associated with the referral request. The server may send data included in the referral request to the referred health care provider, the data enabling the referred health care provider to contact the patient. The server may store data included in the referral request in a database.

### INDEX TO RELATED APPLICATIONS

This application is a continuation-in-part of and claims benefit to U.S. patent application Ser. No. 13/848,170 filed Mar. 21, 2013, the disclosure of which is incorporated herein by reference in its entirety. This application also claims benefit to U.S. Provisional Patent Applications No. 61/834,228 filed Jun. 12, 2013, No. 61/834,241 filed Jun. 12, 2013, and No. 61/860,541 filed Jul. 31, 2013, the disclosure of each of which is incorporated herein by reference in its entirety.

### BACKGROUND OF THE INVENTION

Patients seeking health care often visit multiple doctors. For example, a patient's ordinary physician may refer the patient to a specialist, or the patient may identify a specialist for a medical problem on their own. The patient may have to call and schedule appointments with each doctor separately. When the patient finds appropriate medical specialists, the patient's medical records may be shared among the patient's doctors to ensure consistency and quality of care.

FIG. 1 is a prior art referral process 10. A physician may make their practice known through various marketing techniques 11 (e.g., advertisement, listing in medical directories, referral, etc.). A patient may identify a physician and make an appointment 13. During and/or after the appointment, the physician may refer the patient to another physician 15. The referring physician notifies the patient, and optionally the referred physician, of the referral. The patient may contact the referred physician's office to schedule an appointment 17. The referred physician relies on the patient following the referral in order to be contacted. The referred physician may receive the patient's call and schedule the appointment 19. The patient may therefore enter the referred physician's practice 20 and continue treatment with the referred physician 21.

An initial physician evaluation and referral to a specialist can be time consuming and expensive for the patient. The referring physician may receive limited recognition for a referral and may also lose the patient from his hospital or referral network as the patient seeks alternative avenues for finding a proper physician. Additionally, medical practitioners use a wide variety of Electronic Health Record (EHR) systems which are frequently incompatible and may not interoperate well (e.g., NCEHR, or “non-compatible” EHR systems), making the transfer of patient data from one practice to another difficult or impossible.

### SUMMARY OF THE INVENTION

Systems and methods described herein may help individuals (e.g., patients and healthcare providers) find and connect with healthcare providers and enable communication between healthcare providers independent of the EHR systems involved.

In some embodiments, Short Message System (SMS) technology may be used to connect patients with healthcare providers to match the patient with a provider based on medical need and geographic area quickly and in real time. Other rapid communication methods may also be used. For example, Multimedia Messaging Service (MMS) technology may be used to transmit not only patient contact info, but also a video image of a medical condition to be addressed.

In some embodiments, a referring physician may transmit his or her own contact information and diagnosis. This may generate a record of transmission. Because there is a trail of transmission, subsequent health care providers may have a way to readily contact the referring health care provider if additional inquiries are desired.

In some embodiments, patient data such as healthcare insurance, geography, and medical history may be collected. These patient data components may be compared with a set of possible physician matches, optimizing for cost to patient and/or the insurance company, for example. Messages from the system (e.g., patient appointment requests and/or patient data) may be transferred to possible physician matches based on the analysis.

In some embodiments, information uploaded by patient or physician may be stored on a non-transitory medium for future analysis and improved algorithmic performance.

### BRIEF DESCRIPTIONS OF THE DRAWINGS

FIG. 1 is a prior art referral process.

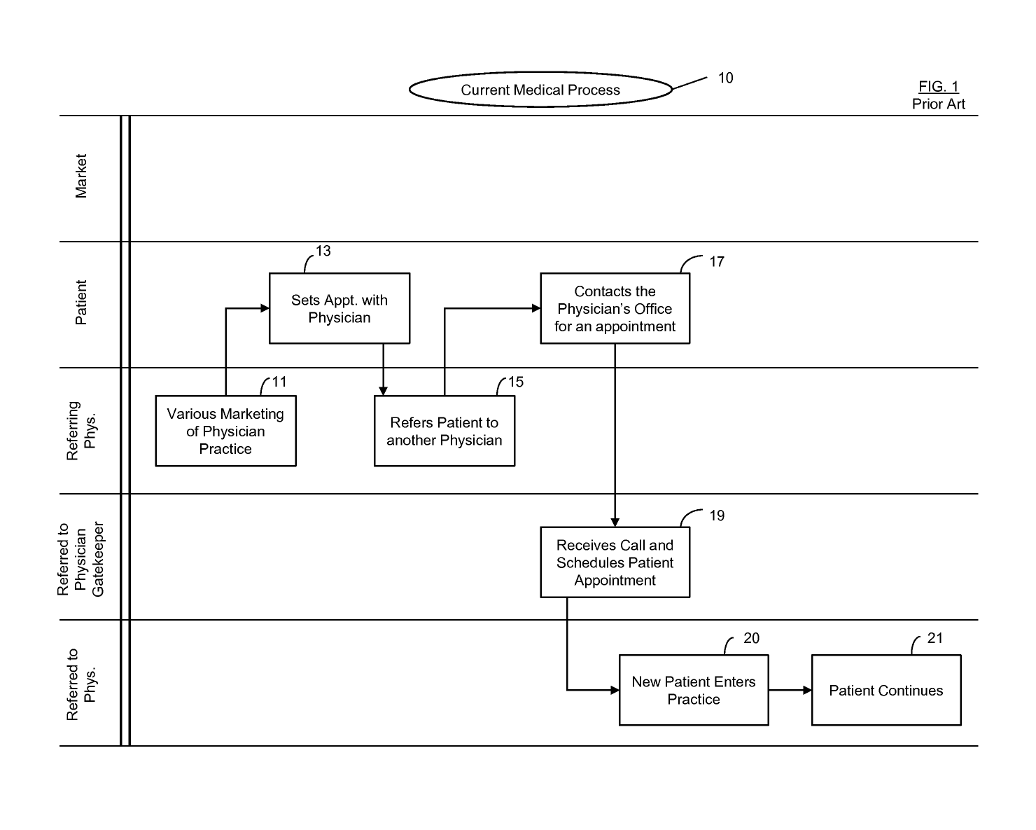

FIG. 2 is a referral and record sharing system according to an embodiment of the invention.

FIG. 3 is a referral process according to an embodiment of the invention.

FIG. 4 is a record keeping process according to an embodiment of the invention.

### DETAILED DESCRIPTION OF SEVERAL EMBODIMENTS

Systems and Methods described herein may be used to provide referrals and to share records (e.g., for medical patients). For example, SMS, MMS, and/or other rapid communications techniques may be used to notify patients and doctors of medical referrals and/or to exchange patient medical data between doctors.

Devices operating the various applications and performing the various processes described herein may comprise one or more computers. Computers may be linked to one another via a network or networks. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via WiFi, WiMax, or other wireless connection). Connections between computers may use any protocols, including connection oriented protocols such as TCP or connectionless protocols such as UDP. Any connection through which at least two computers may exchange data can be the basis of a network.

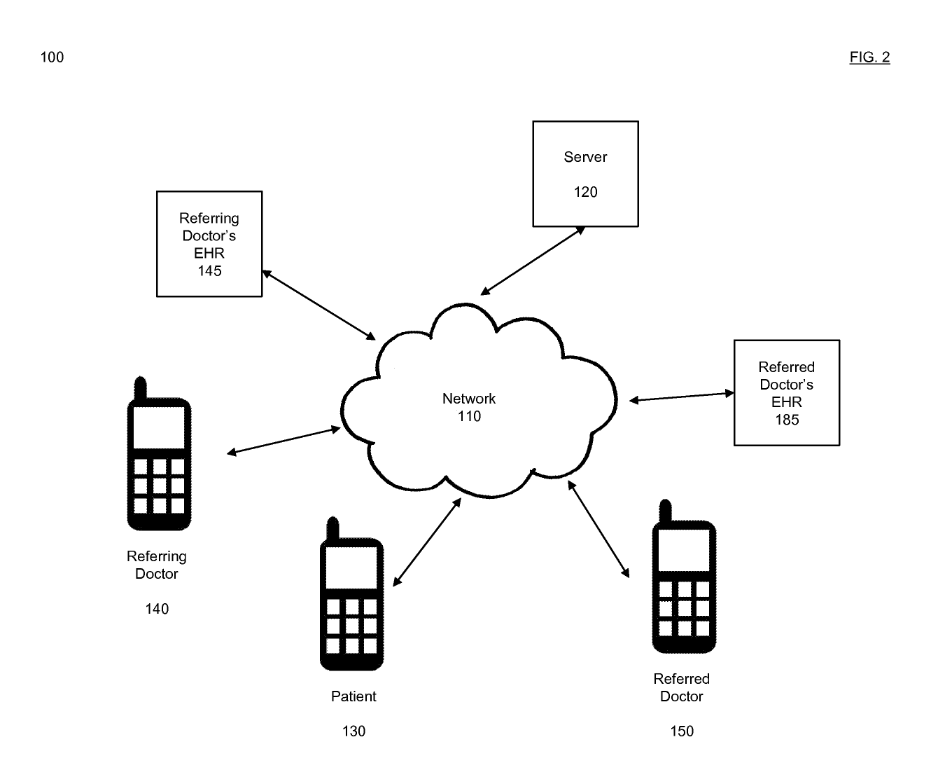

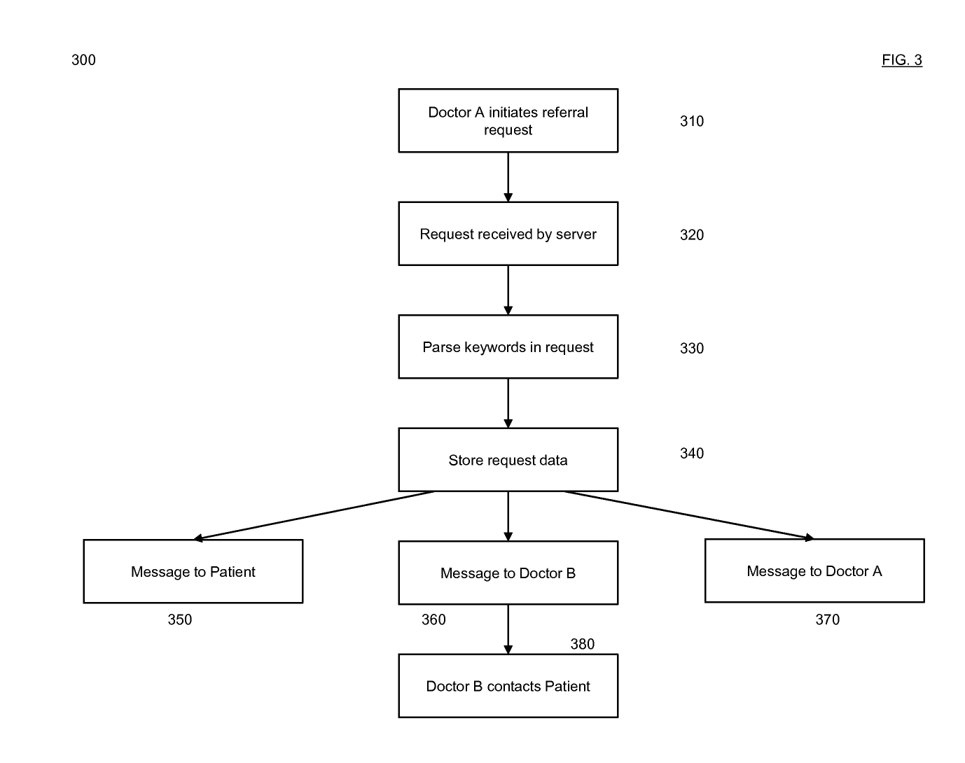

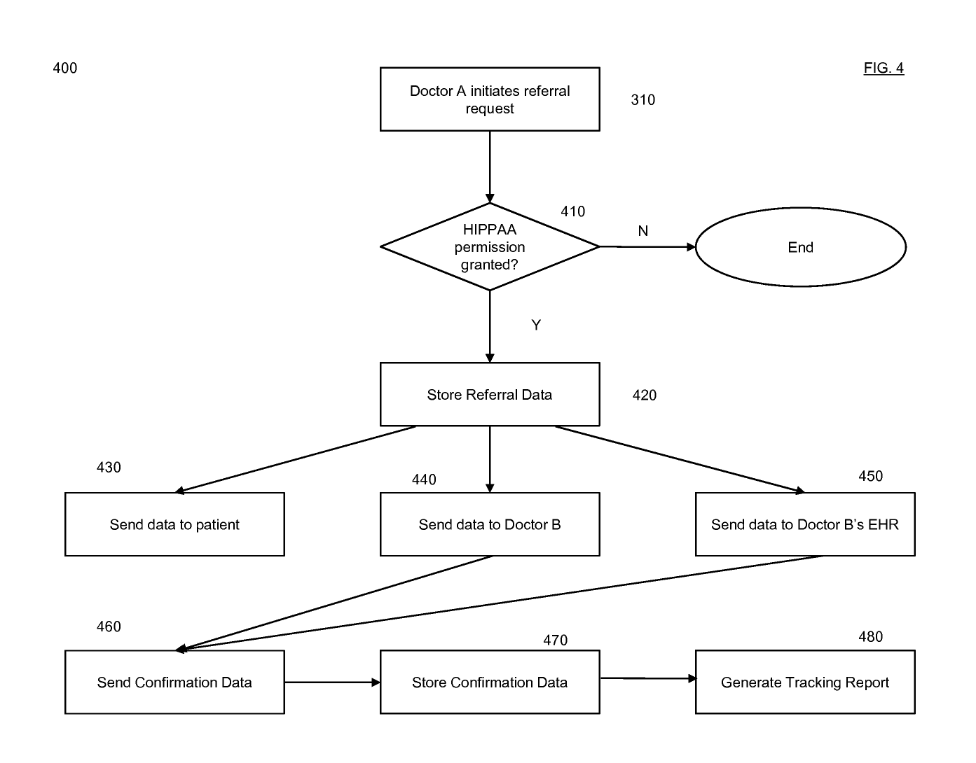

FIG. 2 is a referral and record sharing system 100 according to an embodiment of the invention. The system 100 may include several computers which may communicate with one another via at least one network 110. The network 110 may be, for example, an SMS network, although other networks are possible. The system 100 may include one or more servers 120 which may store data and receive messages from and/or send messages to one or more patient computers 130 (e.g., a patient's smartphone), referring doctor computers (e.g., a doctor's smartphone 140 and/or EHR system 145), and/or referred doctor computers (e.g., a doctor's smartphone 150 and/or EHR system 155). Some example functions of these computers are described in greater detail below in the context of FIGS. 3 and 4.

FIG. 3 is a referral process 300 according to an embodiment of the invention. In this example, a patient at a doctor's office may be given a referral to a specialist. Doctor A (“DrA”) may initiate 310 a request, for example in the form of a SMS message or other electronic message sent via smartphone 140 or in a message initiated within the doctor's EHR 145, in order to connect the patient (“P”) and Doctor B (“DrB”). In the SMS example, the body of the SMS message may be composed to match a predefined syntax including actionable keywords and uniquely identifiable data.

The message may be delivered 320 to the server 120. For example, an SMS may delivered via short code (a 6-digit phone number) through a short message service center (SMSC) gateway of the network 110 to the server 120. The server 120 may parse 330 out the actionable keywords and process the text of the SMS. The request and its data may be stored 340 in a database associated with the server 120. Data relevant to each party (e.g. DrA & DrB & P) may be stored for later retrieval. Assuming the request is correctly formatted (e.g., the server 120 can identify keywords within the message), at least three new messages may be composed and queued for delivery via the SMSC gateway.

The server 120 may process the queue of new SMS messages generated by the initial request by DrA. One message may be delivered 350 to the patient (e.g., to the patient's smartphone 130). This message may contain Dr. B's DOCTOR card and/or a practice card. The DOCTOR card may include a doctor's information (e.g., contact information, specialty, practice group, etc.) and may include a physical display of the SMS which all physicians registered with the system may be assigned. A practice card may include similar information (e.g., contact information, specialty, practice group, etc.) for a practice (e.g., a group of affiliated doctors).

A second message 360 may include a message to DrB (e.g., to DrB's smartphone 150) notifying him of the referrals by DrA along with patient data. Patient data may include contact information for the patient (e.g., an otherwise unidentified mobile number). The Patient data may also include information (e.g., text notes, photos, etc.) about the patient. The number of messages that are sent in this instance may be variable, as DrA may have the ability to connect the Patient with multiple other doctors. In the case of multiple physicians (e.g. DrB0, DrB1, DrB2,) each physician may receive one SMS of a similar nature. The doctor(s) can now contact 380 the Patient for an appointment. A third message 370 may be delivered to DrA (e.g., to DrA's smartphone 140) to confirm the success or failure of the transaction he initiated.

Physicians may be able to reference past leads which they have received or initiated. For example, doctors may be given access to a Web-based platform that compliments the SMS-based procedure. This platform may enable doctors to further extend each transaction with additional notes, tags, statuses, and/or other information.

In the following example, a patient needs to see a physician and has not been referred. He may initiate a request to the system in the form of an SMS with a keyword or series of keywords. The body of the SMS message may be read by the system for actionable keywords to identify an appropriate physician based on the keywords (or a specific doctor name included in the text in some embodiments). The patient may receive a message with the generated DOCTOR card and the physician may receive the patient data for the patient that requested his or her DOCTOR card. The system may record the server's actions and enable the physician to track the referral via a web-based platform. The physician may call or otherwise contact the patient in real time to schedule an appointment or give an alternative referral.

For example, the patient may be looking for a spine surgeon. The patient may send a text message, such as:

“SPINE” to “DOCTOR”(362-867), or

“DRBARUCH” to DOCTOR, or

“NYU,SPINE” to DOCTOR, or

“NYU,SPINE,USHC” to DOCTOR.

In response to this text message, the system may identify the patient's location and analyze the message to identify one or more keywords. For example, the keywords may identify a medical specialty area (e.g., spine), medical facility (e.g., NYU), insurance carrier (e.g., USHC), doctor's name (e.g., Dr. Baruch), etc. The system may provide the patient with contact information of a board certified spine surgeon in his or her zip code or area code. If a specific doctor, insurance carrier, and/or medical facility is requested, the information provided to the patient may be compatible with the request (e.g., the specific doctor may be provided, doctor on the specific insurance plan may be provided, a doctor who works at the specific medical facility may be provided). The spine surgeon or healthcare provider may be provided with the patient's cell phone number. The surgeon's or provider's office and/or a call center may call the patient to schedule an appointment to see the spine surgeon. Actions (e.g., text message receipt, call to patient, appointment booking) may be tracked by the system and made available to the physician or healthcare provider on a website. The physician or healthcare provider may have access to patient information such as:
a) Patient information
b) Referred Physician information
c) Referring Physician information
d) Notes on what happens to the patient
e) Metrics on the referrals between physicians
f) Metrics on the patients searching for physicians

FIG. 4 is a record keeping process 400 according to an embodiment of the invention. Non-compatible EHR systems may be bridged to share information with one another so that doctors involved in the referral process described above have up to date and/or synchronized patient information. A physician may be able to initiate a referral 310 from within their EHR 145 (see FIG. 3) or via SMS or other methods. For example, an icon may be added to an EHR software user interface to allow the user to initiate a referral from within the EHR 145. Clicking on the icon from within one EHR 145 may initiate a referral through the system 100, which may be sent to physicians and/or health providers on a different, possibly non-compatible EHR 155.

Referring physician information, referred physician information, and patient information may be allowed to move seamlessly between these EHR systems, aiding care without requiring physicians to change their current behaviors. If a doctor makes a referral using the EHR 145, the EHR 145 in the sending doctor's office may populate an information transmission with patient information (including, but not limited to, any one or more of: name, cell number, home number, insurance, diagnosis, etc.). The referral may be stored 420 by the server 120 in a database. If the referral includes the patient information, this information may also be stored in the database. The patient information may be automatically transmitted via text or other transmission system to the patient 430, receiving doctor and/or healthcare provider 440, and/or the receivng doctor and/or healthcare provider's office (e.g., the receiving doctor or provider's EHR 155) 450. In some embodiments the transmission system may be selectable by the sending doctor. In some embodiments, before patient information can be shared, the patient must have given approval to send HIPPA-protected details. If such approval has been received 410 from the patient and stored in the server 120, the EHR data may be transferred 420 from the referring doctor's EHR 145 to the server 120.

When a referral is initiated, the referring doctor may be presented with a list of potential providers to refer the patient, which may include sub-specialties of which the provider might not otherwise have knowledge. Because referrals may be made between doctors using incompatible EHRs, the list may be broader than the provider's current network.

By storing referrals and patient information when available, the server 120 may dynamically create an aggregate patient record that reflects the history of care based on the data that is exchanged. For example, by viewing an aggregate record, a medical services provider can not only treat and administer a condition for which the patient is charged, but also tailor the treatment based on other aspects of the patient's condition including concurrent treatment from other health care providers. In one example, a health care provider can select a prescription regimen that is not contraindicated by other current regimens administered by other healthcare providers.

The system may track and document the patient flow through treatment including monitoring and documenting completion of the action for which patient was sent. Accordingly, the record may indicate that action was taken and performed, may create actionable events based on referrals, and/or may close the completed circle of care with NCEHR systems.

For example, the system may confirm that a service/treatment requested was performed by doctor 2 (a referred doctor). Doctor 1 (a referring doctor), doctor 2, and the patient may get confirmation 460 from the server 120 that service/treatment was performed. This confirmation may be stored 470 by the server 120 in the database. Additionally, the referred doctor's EHR 155 may be used to populate updated patient information into the confirmation message. In this case, the updated patient information may also be stored by the server 120 in the database. Thus, the system 100 may provide information that tracks the entirety of the process, from initial entry into the system 100, through process from time patient referred, appointment scheduled, patient seen, and finally, service/treatment provided. A report of the tracking may be generated and selectively provided 480 as desired to patient, medical providers such as doctors, medical health benefits persons/entities, and others as desired.

In addition to tracking the fact that a referral was sent, the system 100 may also treat the referral as an entity in and of itself, capable of undergoing state changes as it goes through various typical workflow scenarios. As discussed above, the tracking report may be updated with referral information and/or specific patient data each time a communication is made to the server 120. Therefore the server 120 may serve as a database of record for the state of the referral, making sure that on the one hand patients are followed up with and get the care they need, and on the other that potential clients of a practice are not lost to the business due to poor record-keeping or follow-through.

For example, referral lifecycles stored by the server 120 may include information such as the following:

“Successful Referral”

Referral Initiated—Pending Action—Scheduled Appointment—Patient Seen

“Referral Made But Pending”

Referral Initiated—Pending Action—Patient Contacted No Answer—Patient Contacted No Answer

“Referral Made And Aborted”

Referral Initiated—Pending Action—Patient Contacted No Answer—Insurance Not Accepted

At each stage in a referral process, a user may be able to query the server 120 for the state of any referrals to which they have access (e.g., a doctor's patients, a patient's own status) and use the stored data as a to-do list to make sure that referrals don't fall through the cracks.

Additionally, an administrator may be able to log into the server 120, for example via a web interface, and get a birds-eye view of some or all pending outbound and inbound referrals, understand where each one is, who is working on which ones, etc. An administrator may also be able to view a console with statistics, graphs, charts, etc. conveying aggregate state of some or all referrals in the system 100, in real-time and/or historically within a date range.

In one referral example, a patient may be in need of a consult with a vascular surgeon. The vascular surgeon may receive an aggregated medical record from each of cardiologist and pulmonary physicians through the system. Thus, treatment can be configured so as to not create contraindications with treatments in place by the cardiologist and pulmonary physicians.

In some embodiments, the system may be able to connect doctors who may otherwise be reluctant to refer patients to one another due to incompatible EHR systems. This may provide a broader provider network to increase and improve the options for new specialist referrals and related healthcare providers. This may potentially provide better matching of providers best suited to a patent's needs.

For example, a patient may be sent by primary care doctor for service to a specialist, the appointment may be made, the appointment may be confirmed, and the patient may be seen. Each of these steps may be performed according to the methods described above. The NCEHR system of the specialist may transfer each of these steps of patient care to the server 120. The primary care doctor may be able to view these records by accessing the server 120, for example via a web interface. This type of multiple step process may be tracked by the system in thousands of similar scenarios in which each treating physician may benefit from the tracking, notification, and confirming of patients' care cycles.

Additionally, in some embodiments a referral may be flagged as “urgent”. This may enable several additional features, such as:
A physician receiving the referral may prioritize certain referrals over others instead of handling them first-come-first-served.
The patient may be made aware of the urgent status in the confirmation message received, to alleviate concerns about a serious condition not being addressed immediately.
A referral flagged as “urgent” may be kicked back to the referring physician if it is not picked up and acknowledged/processed by the referred physician within some period of time.

Some rules and/or legislation may call for “Meaningful Use” of EHR technology. Meaningful Use, as understood in the field, may mean that certain diagnoses result in absolute treatments and communication between patient, doctors, and healthcare services after a patient is discharged from the hospital or sent from the office for treatment. For example, a patient may be diagnosed with pulmonary edema. Multiple steps may occur in treatment and may be teamed, communicated, and executed. The system may be involved in the tracking and communication among numerous NCEHRs, doctors, services, and the patient as each referral is made through the system. In this example, the patient is discharged with diagnosis of pulmonary edema, and may be referred for the following services:
Schedule medical physician follow up
Pharmacy medications
Physician therapy
Blood tests

Some of the components of Meaningful Use may include:
The use of a certified EHR in a meaningful manner, such as e-prescribing.
The use of certified EHR technology for electronic exchange of health information to improve quality of health care.
The use of certified EHR technology to submit clinical quality and other measures.

In other words, providers may be asked to show they are using certified EHR technology in ways that can be measured significantly in quality and in quantity.

The system may deliver “Meaningful Use” to all constituents and their respective NCEHRs. The system (for example using SMS technology and the interconnection of various EHR platforms) may enable patient tracking through completion, provide reminders and confirmations of appointments, and allow healthcare providers to view healthcare provided to the patient. The system may provide several broad functions for the building of Meaningful Use experiences to connect the patient with all of his/her caregivers, for example:
1) connect and transfer data between NCEHRs
2) serve as primary data holder for any entity without an EHR, such as patient, pharmacy
3) interface to remind patient of compliance and update NCEHRs upon completion
4) coordinate care between NCEHRs
5) improve patient communication and tracking for all stages of patient's services

The system may connect NCEHRs with patients, doctors, hospitals, pharmacies, e-prescriptions, etc. in order to provide full visibility of patients' ongoing care and compliance, thus fulfilling the Meaningful Use measures, creating better patient care tracking, and enabling providers to receive stimulus money and avoid paying legislated penalties associated with Meaningful Use legislation in some areas.

Some criteria of Meaningful Use of EHRs intended by the U.S.

government in order to receive incentives may include:
Improve care coordination
Reduce healthcare disparities
Engage patients and their families
Improve population and public health
Ensure adequate privacy and security

U.S. Government Core Requirements for EHR Meaningful Use may include:
1. Use computerized order entry for medication orders
2. Implement drug-drug, drug-allergy checks
3. Generate and transmit permissible prescriptions electronically
4. Record demographics
5. Maintain an up-to-date problem list of current and active diagnoses
6. Maintain active medication list
7. Maintain active medication allergy list
8. Record and chart changes in vital signs
9. Record smoking status for patients 13 years old or older
10. Implement one clinical decision support rule
11. Report ambulatory quality measures to CMS or the States
12. Provide patients with an electronic copy of their health information upon request
13. Provide clinical summaries to patients for each office visit
14. Capability to exchange key clinical information electronically among providers and patient authorized entities
15. Protect electronic health information (privacy & security)

U.S. Government Menu Requirements for EHR Meaningful Use may include:
1. Implement drug-formulary checks
2. Incorporate clinical lab-test results into certified EHR as structured data
3. Generate lists of patients by specific conditions to use for quality improvement, reduction of disparities, research, and outreach
4. Send reminders to patients per patient preference for preventive/follow-up care
5. Provide patients with timely electronic access to their health information (including lab results, problem list, medication lists, allergies)
6. Use certified EHR to identify patient-specific education resources and provide to patient if appropriate
7. Perform medication reconciliation as relevant
8. Provide summary care record for transitions in care or referrals
9. Capability to submit electronic data to immunization registries and actual submission
10. Capability to provide electronic syndromic surveillance data to public health agencies and actual transmission

Additionally, Meaningful Use may include improved communication between physicians and healthcare providers with patient and receiving physician and healthcare providers.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

I claim:

1. A method comprising:
receiving, with a server comprising a processor, a referral request associated with a patient;
identifying, with the server, a referred health care provider based on the referral request;
sending, with the server, data included in the referral request to the referred health care provider, the data enabling the referred health care provider to contact the patient; and
storing, with the server, data included in the referral request in a database.

2. The method of claim 1, wherein the referral request comprises information associated with the patient, a medical condition, contact information, a medical specialty, a medical facility, an insurance carrier, a health care provider, a severity, an urgency, or a combination thereof.

3. The method of claim 1, wherein the referral request comprises a photo, a video, or a combination thereof.

4. The method of claim 1, further comprising sending, with the server, the data included in the referral request from the database to a referring health care provider, the referred health care provider, or a combination thereof.

5. The method of claim 1, further comprising sending, with the server, data associated with the referred health care provider to the patient, a referring health care provider, or a combination thereof.

6. The method of claim 1, wherein the sending and receiving are performed via Internet, SMS, MMS, telephone, or a combination thereof.

7. The method of claim 1, further comprising receiving, with the server, a confirmation from the referred health care provider indicating that an appointment has been scheduled with the patient, that an appointment has been completed with the patient, or a combination thereof.

8. The method of claim 7, further comprising storing, with the server, the confirmation received from the referred health care provider in the database.

9. The method of claim 7, further comprising sending, with the server, the confirmation received from the referred health care provider to a referring health care provider.

10. The method of claim 7, further comprising:
compiling, with the server, the data included in the referral request and data included in the confirmation into a medical record; and
storing, with the server, the medical record in the database.

11. The method of claim 10, wherein the medical record comprises data from an electronic health record (EHR) database associated with a referring health care provider, data from an EHR database associated with the referred health care provider, or a combination thereof.

12. The method of claim 10, further comprising sending, with the server, at least a portion of the medical record to the patient, a referring healthcare provider, the referred health care provider, or a combination thereof.

13. The method of claim 12, further comprising determining, with the server, that patient permission for sending at least the portion of the medical record to a referring healthcare provider, the referred health care provider, or a combination thereof, has been granted.

14. The method of claim 1, further comprising flagging, with the server, the referral request as urgent.

15. The method of claim 1, further comprising:
parsing, with the server, the referral request to identify a keyword;
wherein the identifying of the referred health care provider based on the referral request comprises identifying the referred health care provider based on the a keyword.

16. An apparatus comprising:
a server comprising a processor and a database, the server configured to:
receive a referral request associated with a patient;
identify a referred health care provider based on the referral request;
send data included in the referral request to the referred health care provider, the data enabling the referred health care provider to contact the patient; and
store data included in the referral request in the database.

17. The apparatus of claim 16, wherein the referral request comprises information associated with the patient, a medical condition, contact information, a medical specialty, a medical facility, an insurance carrier, a health care provider, a severity, an urgency, or a combination thereof.

18. The apparatus of claim 16, wherein the referral request comprises a photo, a video, or a combination thereof.

19. The apparatus of claim 16, wherein the server is further configured to send the data included in the referral request from the database to a referring health care provider, the referred health care provider, or a combination thereof.

20. The apparatus of claim 16, wherein the server is further configured to send data associated with the referred health care provider to the patient, a referring health care provider, or a combination thereof.

21. The apparatus of claim 16, wherein the server performs the sending and receiving via Internet, SMS, MMS, telephone, or a combination thereof.

22. The apparatus of claim 16, wherein the server is further configured to receive a confirmation from the referred health care provider indicating that an appointment has been scheduled with the patient, that an appointment has been completed with the patient, or a combination thereof.

23. The apparatus of claim 22, wherein the server is further configured to store the confirmation received from the referred health care provider in the database.

24. The apparatus of claim 22, wherein the server is further configured to send the confirmation received from the referred health care provider to a referring health care provider.

25. The apparatus of claim 22, wherein the server is further configured to:
compile the data included in the referral request and data included in the confirmation into a medical record; and
store the medical record in the database.

26. The apparatus of claim 25, wherein the medical record comprises data from an electronic health record (EHR) database associated with a referring health care provider, data from an EHR database associated with the referred health care provider, or a combination thereof.

27. The apparatus of claim 25, wherein the server is further configured to send at least a portion of the medical record to the patient, a referring healthcare provider, the referred health care provider, or a combination thereof.

28. The apparatus of claim 27, wherein the server is further configured to determine that patient permission for sending at least the portion of the medical record to a referring healthcare provider, the referred health care provider, or a combination thereof, has been granted.

29. The apparatus of claim 16, wherein the server is further configured to flag the referral request as urgent.

30. The apparatus of claim 16, wherein:
the server is further configured to parse the referral request to identify a keyword; and
the server is configured to identify the referred health care provider based on the referral request by identifying the referred health care provider based on the a keyword.
